(19) United States
(12) Patent Application Publication
(10) Pub. No.: US 2004/0193387 A1
(43) Pub. Date: Sep. 30, 2004

(54) Signal recorder with status recognizing function

(76) Inventor: Ho Jinyama, Tsu-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/480,454

(22) PCT Filed: Jun. 10, 2002
(86) PCT No.: PCT/JP02/05760

(30) Foreign Application Priority Data
Jun. 14, 2001 (JP) 2001-180702

(51) Int. Cl. G06F 15/00

(52) U.S. Cl. 702/181; 700/108

(57) ABSTRACT

A signal recording system and signal recording device including a status recognizing method and a status recognizing function of recording feature parameters reflecting the status change and a raw signal for status change and a raw signal for status monitoring with no wasteful recording medium. Feature parameters in the high, medium and low frequency ranges of a signal generated from a sensor are determined by calculation and whether either only the feature parameter or both the feature parameters and a raw signal of a necessary time length are recorded is decided depending on the degree of a status change. In judging the status, the recorded feature parameters are converted into normalized feature parameters conforming to a normal probability density distribution, the status judgment criterion of dimensional and dimensionless feature parameters and normalized feature parameters are determined according to probability examination, confidence interval and possibility theory and the results of judgment of the dimensional and dimensionless feature parameters are integrated, thereby making status judgment. As required, the tendency of status change is managed, the status is predicted and the cause of a status change is analyzed. The status at the measurement is displayed and a warning is given if the status is dangerous.

### 1. FIELD OF THE INVENTION

This invention relates to the status recognizing method and signal recording device for long-time signal recording to monitor the state of objects, which is very suitable, for example, in machinery diagnosis, medical diagnosis and seismic monitoring, wherein status monitoring, trend control of state change, state prediction and investigation of the causes of state change are implemented by recording the feature parameters reflecting their state when it is judged that there is no abnormality or state change, however, by recording both feature parameters and raw signals simultaneously when it is judged that abnormality or state change has taken place.

### 2. DESCRIPTION OF THE PRIOR ARTS

Main signal recording methods previously used have been:

1) Direct and continuous recording of raw signals.

2) Recording at pre-set time intervals.

3) Recording by setting the signal peak value and input level as a trigger.

When signals are recorded for status monitoring, signals reflecting the state change of the objects which are monitored should be recorded as much as possible. For instance, in case of recording of the signals of machinery states, especially recording of raw signals for a long time, big capacity of recording medium is needed. However, it is difficult to record for a long-time by using the present technology of recording medium. When the machine is in normal state, or there is no state change, it is enough for both the state signals and the feature parameters reflecting the state trend to be recorded at a time and thereby, the time of recording the state signals could be shortened. However, if raw signals of the identical state are recorded beyond the need, it would result in the waste of recording medium and time.

On the other hand, in case of state change, it should be sure for signals of the state change to be recorded without fail for analyzing and finding out its cause. However, it is quite difficult by using the prior arts to develop a signal recording device without wasting the recording medium which records status parameters and raw signals reflecting the state.

In case of directly recording the raw signals, not only long-time recording but also catching the state change is difficult.

In case of recording at preset time intervals, state change may not necessarily take place during signal recording periods, while state change may happen within the period of no recording. In other words, it cannot be ensured that the desired signals are recorded and as a result, useless signals can be included.

In the case of recording of signals when the peak value and signal level exceeds the preset threshold, it is also very difficult to determine the threshold value, because the peak value of signals and signal level may not necessarily reflect the state change.

As it is not known in prior arts that the feature parameters for status monitoring conform to which kind of probability density distribution, the accuracy of the judgment cannot be ensured when status monitoring is judged on the statistic theory, in the assumption that the feature parameters follow the normal probability density distribution.

### 3. SUBJECT TO BE SOLVED

In this invention, feature parameters are firstly calculated to the signals measured by sensors in the high, medium and low frequency bands and then feature parameters are converted into “normal feature parameters” which conform to the normal probability density distribution. And then, the criterions for the status judgment of dimensional and dimensionless feature parameters and normal feature parameters are determined based on the probability theory and possibility theory. And then, the status judgment is performed by integrating the judgment results of state change of dimensional and dimensionless feature parameters and it is determined whether either the feature parameters are recorded or the feature parameters and the raw signals for the required time periods are recorded concurrently, according to the degree of state change. When only feature parameters are recorded, the required capacity of recording medium will be far less than that required for continuous recording of raw signals, thereby, long-time recording and status monitoring can be easily implemented.

Furthermore, trend control of state change, state prediction and cause analysis of state change can be implemented by using the recorded raw signals, feature parameters and normal feature parameters. In addition, the state can be displayed and alarm designating dangerous state can be given according to the requirement.

### 4. DETAILED DESCRIPTION OF THE PREFERRED EMBODIMENTS

### 1. Feature Parameters for Status Monitoring

Feature parameters that can be used in signal recording devices include feature parameters of time domain, frequency domain and time-frequency domain. ((1) Peng CHEN, Masami NASU, Toshio TOYOTA: Self-reorganization of symptom parameters in frequency domain for failure diagnosis by genetic algorithms, Journal of Intelligent & Fuzzy System, IOS Press, Vol.6 No1. 1, pp. 27-37, 1998. (2) Peng CHEN, Toshio TOYOTA, Masatoshi TANIGUTI, Feng FANG and Tomoya NIHO: Failure Diagnosis Method for Machinery in Unsteady Operating Condition by Instantaneous Power Spectrum and Genetic Algorithms, Proc. of Fourth International Conference on Knowledge-Based Intelligent Engineering System & Allied Technologies (KES2000), pp. 640-643, 2000)). The feature parameters of time domain are, hereafter, given particulars as a typical example.

1) Dimensionless Feature Parameters

From the measured time serial signals, signals of low, medium and high frequency bands are extracted through filters. The extracted signals x(t) are normalized by the following Equation.

$${x}_{i} = \frac{{x}_{i}^{′} - \overline{x}}{S} \qquad ( 0 )$$

wherein x′ᵢ is the discrete values of \overline{x}(t) after A/D conversion, x and S are respectively the average value and standard deviation of x′ᵢ.

The feature parameters are expressed in the Equations (1)˜(10). ((3) Peng CHEN, Toshio TOYOTA, Yueton LIN, Feiyue WANG: FAILURE DIAGNOSIS OF MACHINERY BY SELF-REORGANIZATION OF SYMPTOM PARAMETERS IN TIME DOMAIN USING GENETIC ALGORITHMS, International Journal of Intelligent Control and System, Vol.3, No.4, pp.571-585, 1999)

p₁=σ/\overline{x}_{abs}; (rate of variation) (1)

wherein

$$\begin{matrix}\begin{matrix}\overline{{x}_{abs}} = {\sum }_{i = 1}^{N} {x}_{i} \vert / N ; & ( absolute mean value , N being the total \\ & number of data )\end{matrix} & \\ \begin{matrix}σ = \sqrt{\begin{matrix}{\sum }_{i = 1}^{N} {( {x}_{i} - \overline{x} )}^{2} \\ N - 1\end{matrix}} ; & ( standard deviation )\end{matrix} & \\ \begin{matrix}{p}_{2} = \begin{matrix}{\sum }_{i = 1}^{N} {( {x}_{i} - \overline{x} )}^{3} \\ ( N - 1 ) {σ}^{3}\end{matrix} ; & ( distortion )\end{matrix} & ( 2 ) \\ \begin{matrix}{p}_{3} = \frac{{\sum }_{i = 1}^{N} {( {x}_{i} - \overline{x} )}^{4}}{( N - 1 ) {σ}^{4}} ; & ( steepness )\end{matrix} & ( 3 )\end{matrix}$$

p₄=\overline{x}ₚ/\overline{x}_{abs} (4)

wherein \overline{xₚ} is the mean value of maximum values (peak values) of waveforms.

p₅=|\overline{xₘₐₓ}|/\overline{x}ₚ (5)

wherein |\overline{xₘₐₓ}| is the mean value of maximum values of 10 waveforms.

p₆=\overline{x}ₚ/σₚ (6)

wherein σₚ is the standard deviation of maximum values

p₇=\overline{x_{L}}/σ_{L} (7)

wherein \overline{x_{L}} and σ_{L} are respectively the mean value and standard deviation of minimum values (valley values).

$$\begin{matrix}{p}_{8} = \frac{{\sum }_{i = 1}^{N} \sqrt{\vert {x}_{i} \vert}}{N \sqrt{σ}} & ( 8 ) \\ {p}_{9} = \frac{{\sum }_{i = 1}^{N} {x}_{i}^{2}}{N {σ}^{2}} & ( 9 ) \\ {p}_{10} = \frac{{\sum }_{i = 1}^{N} log \vert {x}_{i} \vert}{N log σ} ; ( {x}_{i} \neq 0 ) & ( 10 )\end{matrix}$$

The “interval feature parameters” shown in Eq. (11)˜(16) are newly proposed to enable numerical calculation faster and easier, whereas feature parameters in Eq. 1˜10 are already known in the prior arts.

$$\begin{matrix}{p}_{k1} = \frac{{\sum }_{i = 1}^{{N}_{k1}} {x}_{i}}{{N}_{k1}} & ( 11 ) \\ {σ}_{k1} = \sqrt{\frac{{\sum }_{i = 1}^{{N}_{k1}} {( {x}_{i} - {p}_{k1} )}^{2}}{{N}_{k1}}} & ( 12 )\end{matrix}$$

wherein x_{I}≧kσ and k can be set arbitrarily, for example, k=0.5, 1 and 2.

$$\begin{matrix}{p}_{h1} = \frac{{\sum }_{i = 1}^{{N}_{h1}} \vert {x}_{i} \vert}{{N}_{h1}} & ( 13 ) \\ {σ}_{h1} = \sqrt{\frac{{\sum }_{i = 1}^{{N}_{h1}} {( \vert {x}_{i} \vert - {p}_{h1} )}^{2}}{{N}_{h1}}} & ( 14 )\end{matrix}$$

wherein xᵢ≦−hσ and h can be set arbitrarily, for example, k=0.5, 1 and 2.

$${p}_{k2} = \frac{{\sum }_{i = 1}^{{N}_{k1}} {( {x}_{i} - {p}_{k1} )}^{t}}{{σ}_{k1}^{′} {N}_{k1}} \qquad ( 15 )$$

wherein xᵢ>kσ, k and pₖₗ are the same as in Eq. (11) and t can be set arbitrarily, for example, t=2, 3, 4.

$${p}_{h2} = \frac{{\sum }_{i = 1}^{{N}_{h1}} {( \vert {x}_{i} \vert - {p}_{h1} )}^{t}}{{σ}_{h1}^{′} {N}_{h1}} \qquad ( 16 )$$

wherein xᵢ<−hσ, h and Pₕ₁, are the same as in Eq.13 and t can be set arbitrarily, for example, t=2, 3, 4.

2) Dimensional Feature Parameters

In calculation of dimensional feature parameters, the measured signals are not normalized according to Eq.0.

$$\begin{matrix}\begin{matrix}{p}_{d1} = \frac{{\sum }_{i = 1}^{N} \vert {x}_{i} \vert}{N - 1} & & ( absolute mean value of signals )\end{matrix} & ( 17 ) \\ \begin{matrix}{p}_{d2} = \frac{{\sum }_{i = 1}^{N} {x}_{i}^{2}}{N - 1} & & ( effective value of signals )\end{matrix} & ( 18 ) \\ \begin{matrix}{p}_{d3} = \frac{{\sum }_{i = 1}^{{N}_{p}} {\vert {x}_{i} \vert}_{p}}{{N}_{p}} & & \begin{matrix}( mean peak value of \\ absolute value of signals )\end{matrix}\end{matrix} & ( 19 )\end{matrix}$$

wherein |xᵢ|ₚ is the mean peak value of absolute value of signals (maximum value), and Nₚ the total number of peak values.

$${p}_{d4} = \frac{{\sum }_{i = 1}^{{N}_{p}} {\vert {x}_{i} \vert}_{p}^{2}}{{N}_{p}} \begin{matrix}( effective peak value of \\ absolute value of signals )\end{matrix} \qquad ( 20 )$$

Also, many feature parameters can be defined in addition to the above feature parameters and said feature parameters should be firstly used for trial and then other feature parameters can be additionally defined, if the result of state judgment is not good.

### 2. Conversion of Feature Parameters into Normal Probability Variables

The recorded original feature parameters are expressed as P*ᵢ. When p*ᵢ is used to implement status monitoring and state prediction according to the statistic theory, it is necessary in advance to know its probability density or to know if P*ᵢ follows the normal distribution or not. However, as the objects of measurement cannot be specified in advance, the probability distribution of p*ᵢ is not known in most cases.

Therefore, in this invention, the following method is used for the recorded feature parameters p*ᵢ, to convert p*ᵢ into probability variables p*ᵢ in normal distribution.

(1) Method Based on Reference Time

The reference point of time of the object measured, which is, for instance, the point of time in the first measurement, is determined and then the probability density function f (p*ᵢₒ) and the accumulated probability distribution function F (p*ᵢₒ) of the feature parameters p*ᵢₒ at the point of time are calculated. It is assumed that the probability density distribution of standard normal distribution is φ(xᵢ), and the accumulated probability distribution function of standard normal distribution is φ(xᵢ). The probability density function of discrete data p*ᵢₒ can also be referred to as “frequency distribution function” and “histogram”, but they are described as “probability density distribution function” hereafter.

1) Method Based on Mean Values and Standard Deviation by Normal Distribution Conversion

The mean value μᵢₒ which is obtained by normal distribution conversion, can be calculated by the following equation.

μᵢ₀=p*ᵢ₀−σᵢ₀×Φ⁻¹(F(p*ᵢ₀)) (21)

wherein Φ⁻¹ is the inverse function of Φ, σᵢₒ the standard deviation after normal distribution conversion which is obtained by Eq. (22).

$${σ}_{i0} = \frac{1}{f ( {p}_{i0}^{*} )} φ ( {Φ}^{- 1} ( F ( {p}_{i0}^{*} ) ) ) \qquad ( 22 )$$

By substituting feature parameters P*ᵢₖ obtained in the point of time other than reference time into Eq. 21, μᵢₒₖ, which is used for status monitoring and state prediction, can be obtained.

2) Direct Conversion Method of Variable

Feature parameters p*ᵢₖ obtained in the point of time other than reference time are converted into probability variables in normal distribution by Eq.23.

xᵢₖ=Φ^{31 1}(F(p*ᵢₖ)) (23)

Wherein xᵢₖ is also used for status monitoring and state prediction.

(2) Methods not Based on Reference Time

The probability density function fₖ(p*ᵢₖ) and accumulated probability distribution function Fₖ(p*ᵢₖ) of feature parameters P*ᵢₖ, which is obtained from the data measured at optional time, are calculated in the following method.

1) Method of Directly Converting Feature Parameters p*ᵢₖ into Probability Variables μᵢₖ of Normal Distribution

The mean values μᵢₖ, which is converted into normal distribution, are calculated by Eq.(24).

μᵢₖ=p*ᵢₖ−σᵢₖ×Φ^{31 1}(Fₖ(p*ᵢₖ)) (24)

wherein σᵢₖ is calculated by Eq.(25).

$${σ}_{ik} = \frac{1}{{f}_{k} ( {p}_{ik}^{*} )} Φ ( {Φ}^{- 1} ( {F}_{k} ( {p}_{ik}^{*} ) ) ) \qquad ( 25 )$$

μᵢₖ is used for status monitoring and state prediction.

2) Method of Indirectly Converting Feature Parameters p*ᵢₖ into Probability Variables μᵢₖⱼ by Using Probability Density Function

The minimum and maximum values of feature parameters p*ᵢₖ are replaced to (p*ᵢₖ)ₘᵢₙ and (p*ᵢₖ)ₘₐₓ respectively. x*ᵢₖ, which is the value of N new variables taken at equal intervals from (p*ᵢₖ)ₘᵢₙ to (p*ᵢₖ)ₘₐₓ, are replaced to x*ᵢₖⱼ, wherein j=1˜N. N μᵢₖⱼ corresponding to variables x*ᵢₖ are obtained by the substitution of xᵢₖ into Eq. 24, wherein μᵢₖⱼ is also used for status monitoring and state prediction.

The normal probability variables μᵢₒₖ, xᵢₖ,μᵢₖ and μᵢₖⱼ in Eq. 21, 23, 24 and 25 are referred to as “normal feature parameters” and are expressed as pᵢ.

### 3. Method of Judging the State Change on the Basis of Statistic Theory and Possibility Theory

The method to judge the degree of state change on the basis of statistic theory and possibility theory by using the normal feature parameters pᵢ are described hereafter.

(1) Making Judgment on The Basis of Statistic Theory

1) Statistic Test for the Mean Values of Normal Feature Parameters

The values of normal feature parameters pᵢ obtained in state k and state y are replaced pᵢₖ and p_{iy} respectively, wherein i=1˜M (M being the total number of normal feature parameters in use).

The mean value of \overline{pᵢₖ} and \overline{p_{iy}} are set as pᵢₖ and p_{iy}respectively and the standard deviations of pᵢₖ and p_{iy} are set as Sᵢ and S_{iy} respectively. The mean value and standard deviation are calculated by Eq. (26) and (27). ((4) K. A. Brownlee. Statistical Theory and Methodology in Science and Engineering, Second Edition, The University Chicago, 1965)

$$\begin{matrix}\overline{p} = \frac{{\sum }_{j = 1}^{J} {p}_{j}}{J} & ( 26 ) \\ {S}^{2} = \frac{{\sum }_{j = 1}^{J} {( {p}_{j} - \overline{p} )}^{2}}{J - 1} & ( 27 )\end{matrix}$$

Statistical test, whether either \overline{pᵢₖ} and \overline{p_{iy}} are equal or not, are checked by Eq. (28) based on reference (4).

$$\vert {\overline{p}}_{ik} - {\overline{p}}_{iy} \vert > \frac{{S}_{iy}}{\sqrt{J}} {t}_{α / 2} ( J - 1 ) \qquad ( 28 )$$

If the above equation exists, it is determined that “pᵢₖ and \overline{p_{iy}} are not equal” with effective level α, wherein t_{α/2}(J-1) is the percentage of the lower side probability of α/2 with respect to the t distribution of probability density function with freedom J-1.

2) Statistical Test of Variance for Normal Feature Parameters

The equality of Sᵢₖ and S_{iy} are checked by Eq. (29). ((5) K. A. Brownlee. Statistical Theory and Methodology in Science and Engineering, Second Edition, The University Chicago, 1965)

$$\frac{{S}_{ik}^{2}}{{S}_{iy}^{2}} > {F}_{α / 2} ( J - 1 , J - 1 ) or \frac{{S}_{iy}^{2}}{{S}_{ik}^{2}} > {F}_{α / 2} ( J - 1 , J - 1 ) \qquad ( 29 )$$

If the above equation exists, it is determined that “Sᵢₖ and S_{iy} are not equal” with effective level α, wherein t_{α/2}(J−1, J−1) is the percentage of the lower side probability of α/2 with respect to the F distribution of probability density function with freedom J-1.

When the effective level α is changed, the degree of state change of state y with respect to state k is determined by confirming whether either Eq. (28) or Eq. (29) is satisfied. An example to determine the degree of state change depending on the effective level a is shown in Table 1. The judgment whether either state y is in normal, caution or dangerous is made by setting as “normal” (α1), “caution” (α2) and “danger” (α3) as shown in Table 1, wherein the state k is in the normal state in machinery diagnosis.

TABLE 1
Example of judging the degree of state change
depending on effective level

| | No state | Medium state | Large state |
|---|---|---|---|
| | change | change | change |
| | (normal) | (caution) | (danger) |
| Effective level | α1 | α2 | α3 |
| (example) | (0.4) | (0.10) | (0.005) |

The figures in Table 1 show that either Eq. (28) or Eq. (29) comes into effect only when a becomes that value.

3) Judgment by the Confidence Interval

The mean value of normal feature parameters obtained from the data measured at the reference time is assumed \overline{pᵢ₀} and the mean value of normal feature parameters obtained from data measured at other time is assumed \overline{pᵢₖ}. Then the confidence interval of \overline{pᵢₒ} is given in the Eq. (30).

\overline{pᵢ₀}±t_{σ/2}(J−1)Sᵢ₀/\sqrt{J} (30)

wherein t_{α/2}(J−1) is the percentage of the lower side probability of α/2 with respect to the t distribution of probability density function with freedom J−1. Sᵢₒ is the standard deviation of \overline{pᵢₒ}.

If \overline{pᵢₖ} is within the interval shown in Eq. (30), it is judged that there is no difference between \overline{pᵢₖ} and \overline{pᵢₒ} with the probability α.

When 10<J<50, the 99% confidence interval of \overline{pᵢₒ} is expressed approximately as follows.

\overline{pᵢ₀}±3Sᵢ₀/\sqrt{J} (31 )

If \overline{pᵢₖ} is beyond the range in Eq. (31), it is judged that \overline{pᵢₖ} is different from \overline{pᵢₒ} with the probability of 99%.

Moreover, the confidence interval of \overline{pᵢₖ}obtained from the measured data is given in (32).

\overline{pᵢₖ}±3Sᵢₖ/\sqrt{J} (32)

wherein Sᵢₖ is the standard deviation of pᵢₖ.

α in Table 1 is substituted into Eq. (30) and then the following confidence intervals are obtained in the following equations.

\overline{p₀}±t_{0.2}(J−1)Sᵢ₀/\sqrt{J} (interval without state change) (normal) (33)

\overline{p₀}±t_{0.05}(J−1)Sᵢ₀/\sqrt{J} (interval with medium state change) (caution) (34)

\overline{p₀}±t_{0.0025}(J−1)Sᵢ₀/\sqrt{J} (interval with large state change) (danger) (35)

State change is judged by that whether \overline{pᵢₖ} is within these intervals or not.

(2) Judgment Based on Possibility Theory

1) Preparation of Possibility Distrbution Function

After the values of normal feature parameters Pᵢ are calculated by the signals measured in state k, the possibility distribution function Pₖ (Pᵢ) is obtained from probability density function fₖ (Pᵢ) in Eq. (36).

According to the possibility theory ((6) L. Davis: HANDBOOK OF GENETIC ALGORITHMS, Van Nostrand Reinhold, A Division of Wadsworth, Inc(1990)), the possibility distribution function of Pᵢ can be obtained no matter which probability distribution it follows. For instance, when Pᵢ follows the normal distribution, the possibility distribution function of Pₖ (Pᵢ) in segment N is calculated as follows.

$${P}_{k} ( {p}_{ix} ) = {\sum }_{y = 1}^{Y} min \{ {λ}_{x} , {λ}_{y} \} \\ wherein \\ {λ}_{x} = {\int }_{{p}_{ix - 1}}^{{p}_{ix}} \frac{1}{{S}_{i} \sqrt{2 π}} exp \{ - \frac{{( p - \overline{{p}_{i}} )}^{2}}{2 {S}_{i}^{2}} \} ⅆ p \\ {λ}_{y} = {\int }_{{p}_{iy - 1}}^{{p}_{iy}} \frac{1}{{S}_{i} \sqrt{2 π}} exp \{ - \frac{{( p - \overline{{p}_{i}} )}^{2}}{2 {S}_{i}^{2}} \} ⅆ p \qquad ( 36 )$$

In the above Eq., Pᵢₓ=min {Pᵢ}+x×(max {Pᵢ})/N, x =1˜N, Sᵢ is the standard deviation of Pᵢ, and \overline{Pᵢ} is the mean value of Pᵢ.

2) Method of Obtaining Possibility

As shown in FIG. 1, the possibility distribution functions of normal feature parameters Pᵢ in state k and state y are replaced by Pk (Pᵢ) and P_{y} (Pᵢ) respectively and the values of normal feature parameters in state y are replaced by P′ᵢ. Then the possibility w that “state y is identical with state k” is obtained as follows.

a) Determination of w by the matching of the mean value P_{i mean} of Pᵢ with Pₖ (Pᵢ),

b) Determination of w by the matching of P_{y} (Pᵢ) with Pₖ (Pᵢ).

The equation to obtain w by the matching of P_{y} (Pᵢ) with Pₖ (Pᵢ) is shown in Eq. (37).

$$w = {\sum }_{x = - ∞}^{+ ∞} {P}_{k} ( {p}_{ix} ) \cdot {P}_{y} ( {p}_{ix} ) \qquad ( 37 )$$

3) Judgment of the State Change

After the possibility distribution function Pₖ (Pᵢ) of the normal feature parameters Pᵢ in the state k is obtained, the possibility distribution function (P_{c1} (Pᵢ) and P_{c2} (Pᵢ), which is in small state change on both left and right sides and the possibility distribution function (P_{d1} (Pᵢ) and P_{d2} (Pᵢ) ), which is in big state change on both left and right sides, are determined as shown in FIG. 2.

The i and j in boundary values

\overline{pᵢ}±iSᵢ, \overline{pᵢ}±jSᵢ

is determined by user input, where standard values are i=3 and j=6.

In the equipment diagnosis, the possibility distribution function are set Pₖ (Pᵢ) for normal state, P_{c1} (Pᵢ) and P_{c2} (Pᵢ) for caution state and P_{d1} (Pᵢ) and P_{d2} (Pᵢ) for dangerous state, respectively. The possibility of “normal”, “caution” and “danger” obtained in actual recognition is as shown in FIG. 3. An alarm can be given when it is judged as “dangerous”.

(3) Status Monitoring Method by Integrating Several Feature Parameters into One

It is also possible to judge the state by integrating several feature parameters into one, wherein integrating method is, for example, the status monitoring method based on genetic algorithms or statistical method. ((8) International Patent Application: No.PCT/JP00/03006, Application No.: 2000-618695), the neural network and main composition analysis method ((9) Otsu, Kurita and Sekida: Graphic Identification, Asakura Bookstore (1996)), (10) Gan Li: Numerical Theory for Neural Network, Industrial Press (1978), (9) K. Fukunaga: Introduction to Statistical Pattern Recognition, Academic Press (1972), and (11) Toshio TOYOTA: Research Report on Practical Application of Latest Equipment Diagnosis Technology, Legal Corporate Japan Plant Maintenance Association, (1999), etc)

(4) Judging the State Change by Integrating the Judgment Criterion of Dimensional and Dimensionless Feature Parameters

Dimensional feature parameters represent the magnitude of signal waveform and dimensionless feature parameters represent the shape characteristics of signal waveform. For instance, in the equipment diagnosis, dimensional feature parameters change with the change in speed and load even in the normal state. Accordingly, the monitoring of the state change is effective by integrating the dimensional and dimensionless feature parameters.

1) Judgment Criterion For Dimensional Feature Parameters

In the diagnosis of rotating machine, the judgment criterion for dimensional feature parameters in the low, medium and high frequency bands are as shown in FIGS. 4, 5 and 6.

In the figures, k is a default value which is set as 1 although it is adjustable. For example, k is lowered by 0.2 when the sensitivity is desired to increase with steps of 0.2 and on the contrary, k is increased by 0.2 when the sensitivity is desired to be lowered.

Herein, the signals measured in the low frequency bands are vibration speeds, while those in the medium and high frequency bands are acceleration. FIGS. 4, 5 and 6 show the judgment criterion for rotating mechanical equipment and the judgment criterion for other measuring objects should be pre-set as shown in FIGS. 4, 5 and 6.

2) Judgment Criterion for Dimensionless Feature Parameters

In the equipment diagnosis, the judgment criterion for dimensionless feature parameters is determined by the statistical test as shown in Table 1, or by the confidence interval shown by Eq. (33), (34) and (35), or by the possibility distribution function shown in FIG. 2.

3) Integration of Judgment Criterion of Dimensional and Dimensionless Feature Parameters

FIG. 7 shows the integration of judgment criterion for dimensional and dimensionless feature parameters. The following remarks are made in this figure.

(a) When status monitoring is performed by a number of dimensionless feature parameters, the judgment results of the feature parameters where state change is big, has priority. For instance, when p₁˜p₃ are used for equipment diagnosis, the following inspection results are given in the low, medium and high frequency bands.

The judgment result by p₁: “normal”, “caution” and “normal”

The judgment result by P₂: “caution”, “danger” and “normal”

The judgment result by p₃: “normal”, “normal” and “normal”

Thereby, the final judgment result is judged “danger” as the judgment result by P₂ is “danger” in the medium frequency bands.

(b) When a status monitoring is examined by a number of dimensional feature parameters, the final judgment result is determined in the same way as (a) above.

(c) When a number of feature parameters described in (3) are integrated into one, the judgment criterion based on the integrated feature parameter is determined by each integration method. For instance, when the feature parameters are integrated by the main composition analysis method, the χ² inspection method is applied for status monitoring. ((12) Toshio TOYOTA: Research Report on Practical Application of Latest Equipment Diagnosis Technology, Legal Corporate Japan Plant Maintenance Association, (1999), etc)

(d) The final judgment result by integrating the judgment criterion of dimensional and dimensionless feature parameters can be directly displayed in characters on the screen of the plant. The state change can be indicated by color lamps (referred to as “state lamps”) in compliance with the state change as shown in FIG. 7.

4) Indication of Results

The indication example of the judgment results by dimensional and dimensionless feature parameters and the judgment results by integrating judgment criterions, which is indicated by state lamps, are shown in FIG. 8. Wherein, the judgment results for non-dimensional feature parameters indicate the probability of the state or the degree of possibility.

### 4. Trend Management for State Change

The diagrams of trend management of state change by normal dimensional and dimensionless feature parameters are shown in FIGS. 9 and 10. In addition, the diagram of trend management of state change of dimensional feature parameters is shown in FIG. 11. Wherein the k in FIGS. 9 and 10 is the same as k in FIG. 4.

### 5. State Prediction

It is relatively easier to predict the state of the measured objects by the previous state prediction methods after the feature parameters pᵢ is obtained. ((13) Shincho ISHIKAWA and Hakamichi MUTO: Prediction Method, Metering and Control, March 1982. (14) Ogawa, M.: Time series analysis and stochastic prediction, Bull. Math. Stat., 8, 8-72, 1958)

### 6. Process Flow

The process flow for the signal recording system proposed in this invention is shown in FIG. 12. A signal recording system can be composed by separating signal recording device from the external computer, as shown in FIG. 13. In such a way, as the burden of the computational processing by the signal recording device can be lessened, the signal recording device can be made compact which is easily set in the field. The external computer has functions for setting the measurement conditions, making the judgment criterion, managing the state trend, implementing the precision diagnosis and analyzing the cause by communicating data with the signal recording device.

Further, when implementing precision diagnosis and cause analysis, the condition monitoring method by genetic algorithms, neural network and main composition analysis methods can also be used.

### 5. EXAMPLE OF THE EMBODIMENT

FIG. 14 shows the time serial signals measured by a speed sensor installed on the shaft of a rotating machine. The state of the machine is changing from normal state to unbalance state. To identify the state, the dimensionless feature parameters (p₁˜p₆) shown in Eq. (1)˜(6) and the dimensional feature parameters (p_{d1}˜p_{d3}) shown in Eq. (15)˜(17) are used.

FIG. 15 shows the judgment result by dimensionless feature parameters (p₁˜p₅) and FIG. 16 shows the judgment result by dimensional feature parameters (P₆). According to these results, as P₆ is more sensitive in judging the state as compared with other dimensionless feature parameters, P₆ is used as judgment result by dimensionless feature parameters, as shown in FIG. 16.

FIG. 17 shows the judgment results by dimensional feature parameters.

The final judgment result by the integration of the judgment results of dimensional and dimensionless feature parameters is shown in FIG. 18.

Although the degree of state change in normal state is indicated by the state lamps, the degree of state change in the last state become the criterion to determine if raw signals are to be recorded or not. For instance, the raw waveform of “measurement 1 (normal) ”, “measurement 3 (medium state change)” and “measurement 7 (big state change)” are recorded by the integrated judgments in FIG. 18.

In this example, as the signals from the measurement 3 to the measurement 8 are in the same state (unbalanced), it is considered that the records of original signals based on the above judgment result are sufficient to explain the cause of abnormality (precision diagnosis). If other abnormal state takes place during the measurement, as in this example, the dimensional and dimensionless feature parameters used for status monitoring are reflected in its state change and raw signals of state change are recorded at appropriate time.

An example of the circuit diagram of the signal recording device is shown in FIG. 19, wherein, 1: sensor, 2: charging amplifier, 3: filter module, 4: chip CPU, 5: result display, 6: RAM for data, 7: AD converter, 8: DC port, 9: SCI, 10: CPU, 11: flash ROM, 12: external computer.

This signal recording device can be designed to have a number of channels. In addition, the external computer can be used to set the recording conditions for signal recording device and the condition monitoring criterion, to read the feature parameters and raw signals and to implement the trend management of the state change and cause analysis.

### 6. EFFECT OF THE INVENTION

This invention is effectively used for a long-time status monitoring in machinery diagnosis, medical diagnosis and seismic monitoring, wherein the dimensional and dimensionless feature parameters reflecting their state are recorded when it is judged that there is no obvious abnormality or state change. On the other hand, both the feature parameters and raw signals are simultaneously recorded when it is judged that there is obvious abnormality or state change. These are useful for trend control, cause analysis of the state change and analysis of the cause in abnormality or state change.

Thus, the waste of signal recording medium can be reduced. Further, feature parameters reflecting state change and raw signals can be recorded at appropriate time by utilizing the signal recording system and device of this invention. And, the recorded feature parameters are converted into normal feature parameters conforming to normal probability density distribution, the criterion of dimensional and dimensionless feature parameters for status monitoring and normal feature parameters for status monitoring is determined via probability theory, confidence interval and possibility theory and status monitoring is performed by the integration of the judgment results of dimensional and dimensionless feature parameters. Further, trend control of state change, state prediction and cause analysis of state change are performed and also the state at the measurement time is displayed and alarm is given in the case of the dangerous state, as required.

### 7. BRIEF DESCRIPTION OF THE DRAWING

FIG. 1 is a graph showing an example of possibility distribution function;

FIG. 2 is a graph showing judging the state change by possibility function;

FIG. 3 is a graph showing the example of the presentation of possibility;

FIG. 4 is a graph showing the judgment criterion of dimensional feature parameters in low frequency bands;

FIG. 5 is a graph showing the judgment criterion of dimensional feature parameters in medium frequency bands;

FIG. 6 is a graph showing the judgment criterion of dimensional feature parameters in high frequency bands;

FIG. 7 is a graph explaining the integration of the judgment criterion of dimensional and dimensionless feature parameters;

FIG. 8 is a graph showing the presentation example of judgment result;

FIG. 9 is a graph showing trend management of state change by normal dimensional feature parameters;

FIG. 10 is a graph showing the trend management of state change using normal dimensionless feature parameters;

FIG. 11 is a graph showing the trend management of state change by dimensional feature parameters;

FIG. 12 is the flow chart showing the processing flow of a signal recording system;

FIG. 13 is the flow chart showing the processing flow of signal recording with external computer separated from signal recording device;

FIG. 14 is a graph showing an example of the measured original signal;

FIG. 15 is a graph showing an example of judgment result with dimensionless feature parameters (p₁˜p₅);

FIG. 16 is a graph showing an example of judgment result with dimensionless feature parameters p₆;

FIG. 17 is a graph showing an example of judgment result with dimensional feature parameters (p_{d1}, p_{d2} and p_{d3});

FIG. 18 is a graph showing an example of judgment result by integrating the dimensional and dimensionless feature parameters; and

FIG. 19 is a circuit diagram showing an example of the circuit of a signal recording device, wherein, the signs in the figure are as follows.

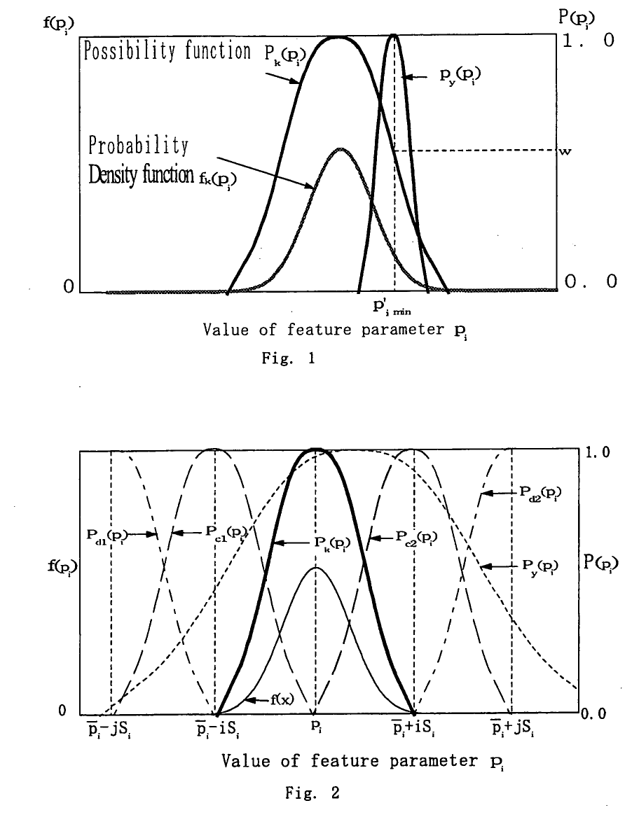

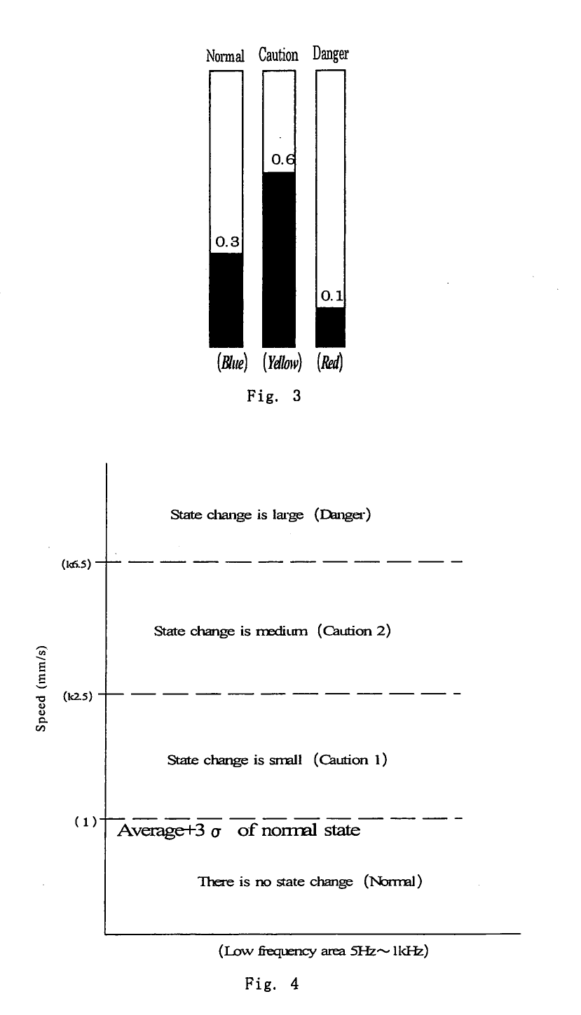

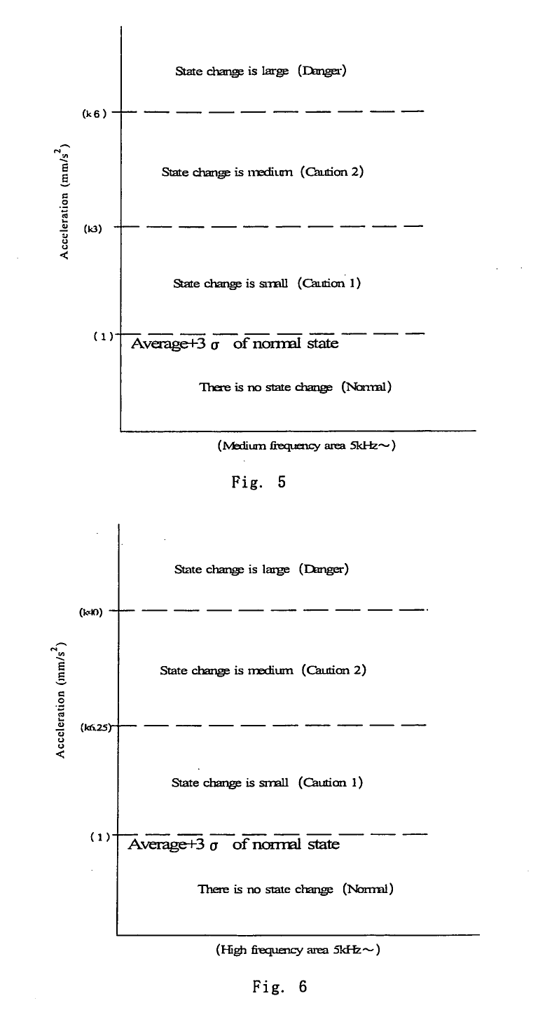

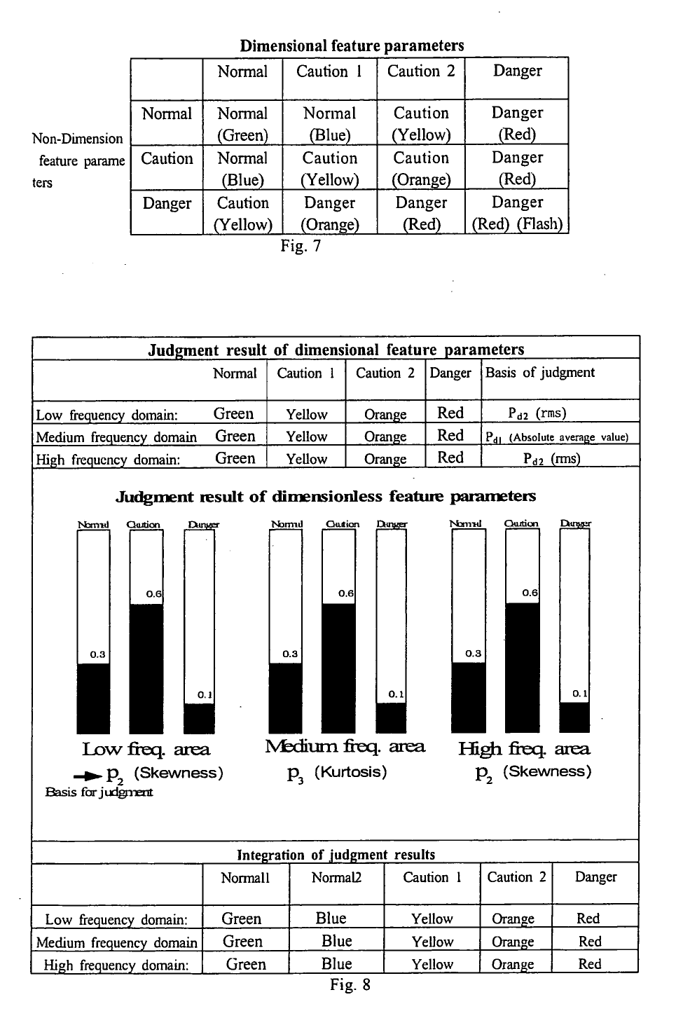

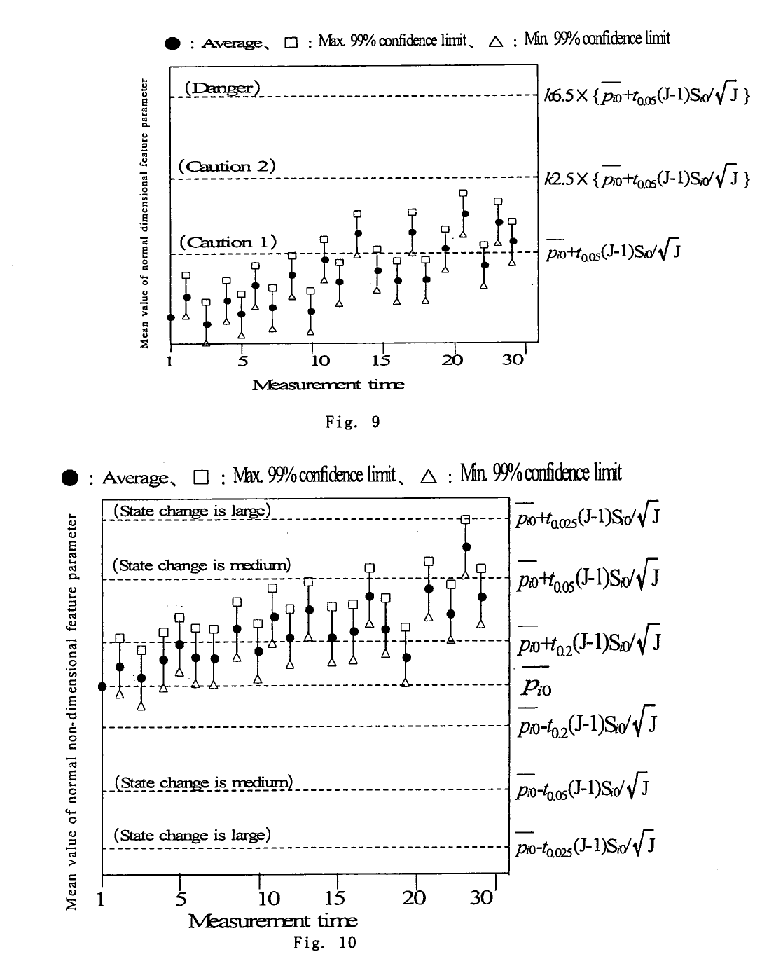

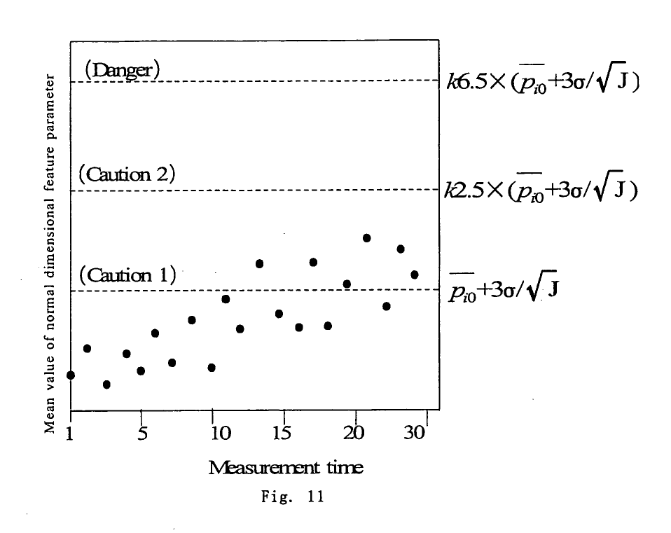

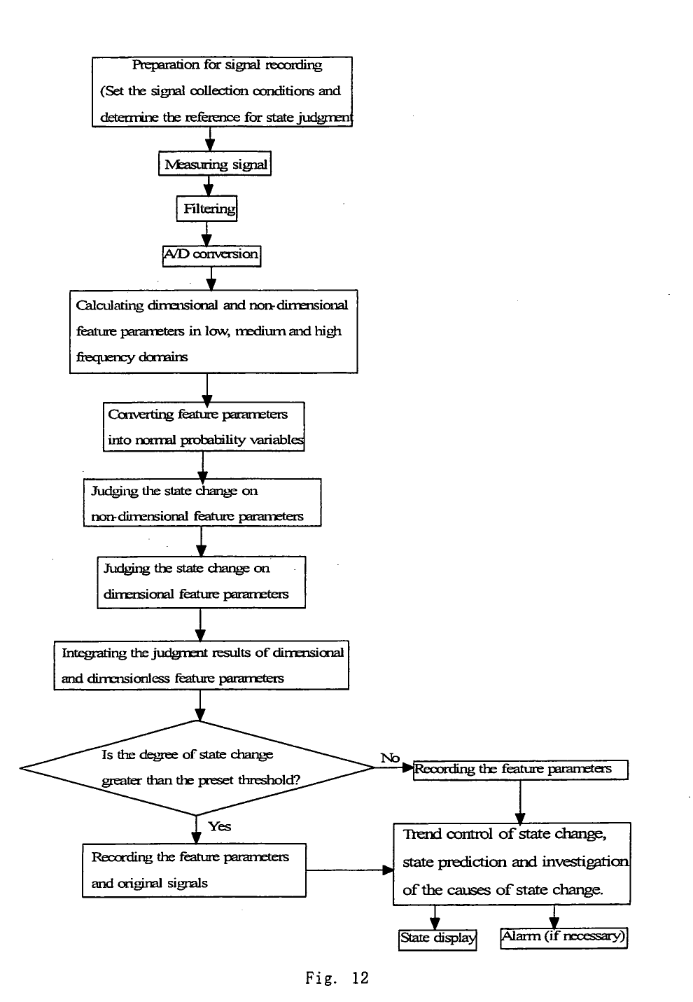

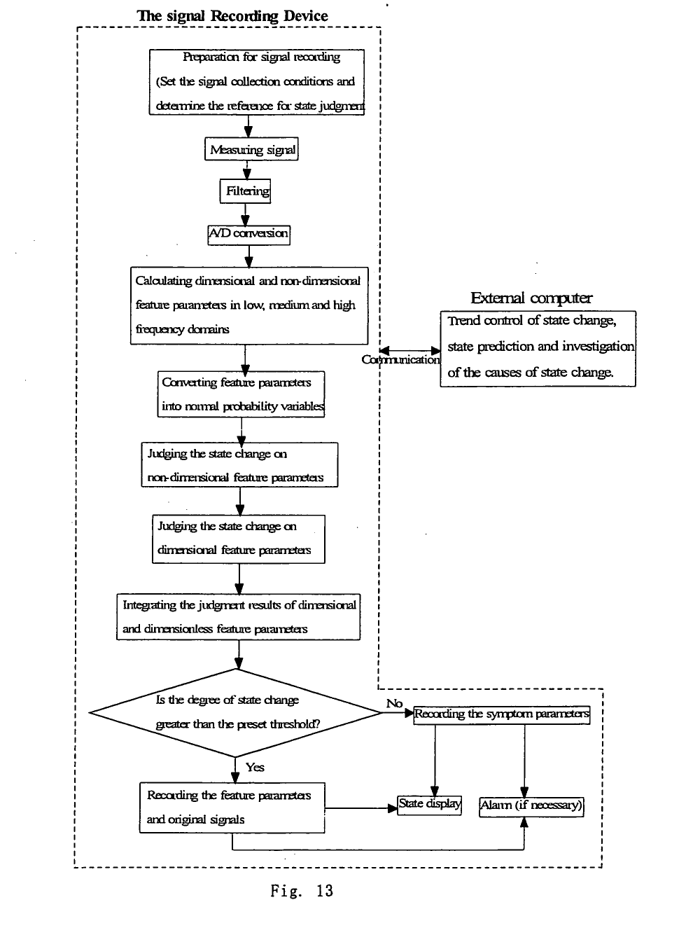

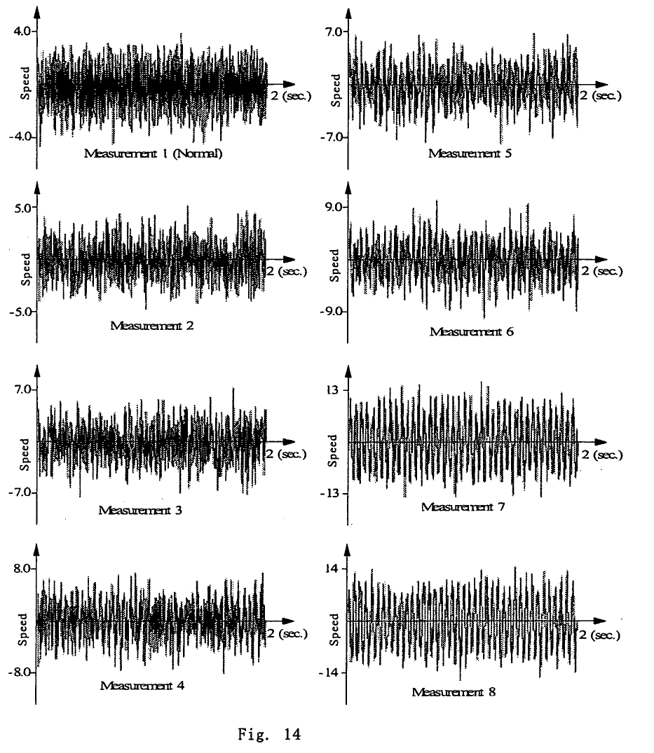

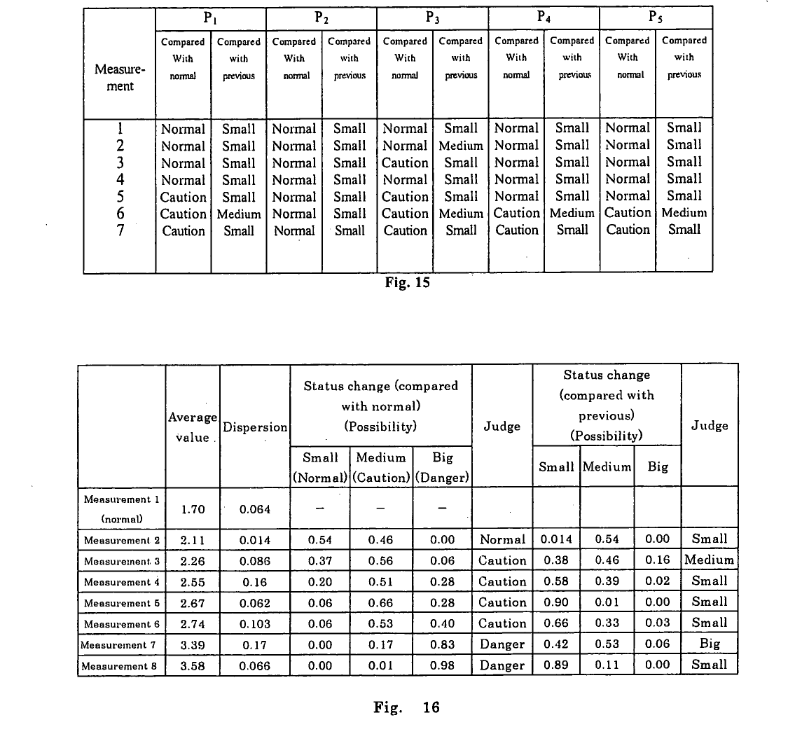

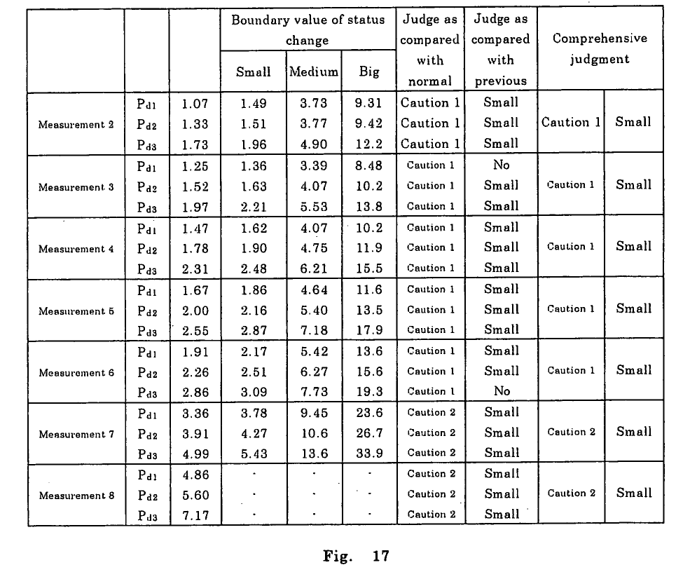

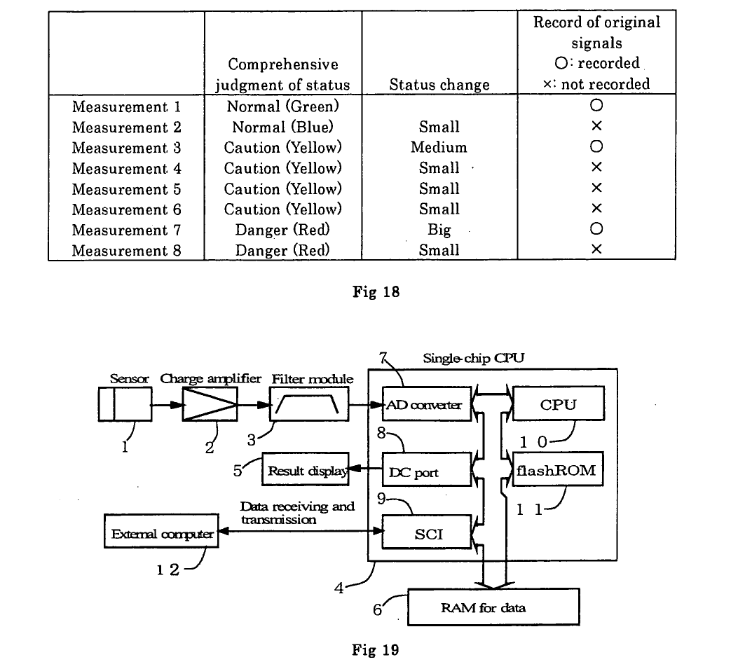

1: sensor, 2: charging amplifier, 3: filter module, 4: chip CPU, 5: result display, 6: RAM for data, 7: AD converter, 8: DC port, 9: SCI, 10: CPU, 11: flash ROM, 12: external computer.

1. A signal recording system and a signal recording device comprising:
means for calculating a feature parameter in each of frequency bands by using a signal of an object measured by a sensor;
means for performing conversion of the calculated feature parameter into a normal feature parameter conforming to normal probability density distribution;
means for performing state judgment, trend control of state change, and state prediction by using the normal feature parameter obtained through said conversion;
means for laying down a criterion of the state judgment of a dimensional feature parameter and a non-dimensional feature parameter based on a statistical test, a confidence interval, and a possibility theory for judging a degree of the state change;
means for laying down a criterion of the state judgment of the normal feature parameter based on the statistical test, the confidence interval, and the possibility theory;
means for judging the degree of the state change by integrating a result of the state judgment of the dimensional feature parameter and the non-dimensional feature parameter;
means for determining whether only the feature parameter in each of the frequency bands is recorded or the feature parameter in each of the frequency bands and a raw signal in time sequence are concurrently recorded, based on the result of the state judgment; and
means for displaying the degree of the state change by means of probability and an order of possibility, the display means being a state lamp.
